(19) United States
(12) Patent Application Publication
(10) Pub. No.: US 2009/0288247 A1
(43) Pub. Date: Nov. 26, 2009

(54) Sani-Spa System Design

(76) Inventor: Nhien Nguyen, Green Bay, WI (US)

Correspondence Address: STEVEN H GREENFIELD, 4649 SEMINOLE TRAIL, GREEN BAY, WI, 54313, US

(21) Appl. No.: 12/126,907

(22) Filed: May 25, 2008

(51) Int. Cl. A61H 33/10

(52) U.S. Cl. 4/541.6

(57) ABSTRACT

The present invention is for a modular spa system design that is easy to disassemble for cleaning and eliminates water lines and the need for using cleaning chemicals. The invention comprises of at least one enclosure molded into the sidewall of the basin shell that forms a bathing tub. Each enclosure has an inside recessed surface and contoured side walls. A water supply and distribution channel system is molded into the inside surface of each enclosure and a detachable partition plate designed to fit the enclosure side walls is placed into the enclosure. Each partition plate contains at least one water jet threaded into the partition such that the jets are in direct communication with the channel system. Embodiments for introducing air into the water are also disclosed. A circulating pump takes the water feed from the tub and circulates it through the channel and the jets.

### FIELD OF THE INVENTION

The present invention relates to an improved bathing system applicable to spas, hot tubs, Jacuzzis, whirlpools and foot tubs.

### BACKGROUND OF THE INVENTION

Present designs for water tubs used for relaxation and therapeutic treatments such as spas, Jacuzzis, whirlpools, hot tubs and foot tubs are compact and closed. The water lines and manifolds that supply water to the jets located on the surface of the tub and spa shells are often enclosed inside compartments that are not easily accessible, making cleaning the lines difficult and time consuming. Cleaning chemicals harmful to the environment are often used to flush the water lines in order to kill bacteria and rinse out deposit build-ups inside the lines. One solution is presented in Pre-grant Publication number 20070289057 in which a molded shell tub has one or more hollows, and each hollow contains a canister that comprises a jet plate located at the front of the canister. The canisters are removable for easy upgrading and repair of the bathing system. However, water lines and associated connectors are still used in the bathing system disclosed in Pre-Grant Publication number 20070289057. It is thus anticipated that disassembling and cleaning the bathing system described in this publication will still be time consuming and require cleaning chemicals.

### SUMMARY OF THE PRESENT INVENTION

An improved design for spas, hot tubs, Jacuzzis, whirlpools, and foot tub bathing systems is disclosed. The present invention represents a modular spa system design that is easy to disassemble for cleaning and eliminates water lines and thus the need for using cleaning chemicals. The system can also be easily reassembled for continued use. The invention comprises of at least one enclosure molded into the sidewall of the basin shell that forms a bathing tub. Each enclosure has an inside recessed surface and contoured side walls. A water supply and distribution channel system is molded into the inside surface of each enclosure and a detachable partition plate designed to tightly fit the enclosure side walls is placed into the enclosure. Each partition plate contains at least one water jet threaded into the partition such that the jets are in direct communication with the channel system when the plate is installed. Several embodiments for introducing air into the water to create a bubbling effect in the jets are also disclosed. A circulating pump takes the water feed from the tub and circulates it through the channel and the jets. This design eliminates the need for internal water lines and the use of cleaning chemicals and makes cleaning the bathing system substantially easier and more environmentally friendly.

### BRIEF DESCRIPTION OF THE DRAWINGS

FIG. 1 is a front side perspective view of an enclosure and the partition plate.

FIG. 1a is a front side perspective view of the enclosure in FIG. 1 further indicting one of the embodiments of an air supply system to the water jets.

FIG. 2 is a side view of the enclosure indicating a cross section of the shell, channel and the partition plate and one of the embodiments of an air supply system to the water jets.

FIG. 2a is a side view of the enclosure of FIG. 2 indicating a different embodiment of an air supply system to the water jets.

FIG. 3 is a side cross-sectional view of two enclosures in a tub shell.

FIG. 4 is a top side perspective view of a tub section having a back rest plate fitted with jets and bolts representing one embodiment of the present invention.

FIG. 5 is a top side perspective view of the tub of FIG. 4 showing the partition plate and the enclosure.

FIG. 6 is a top side perspective view of a tub section comprising a seat representing one embodiment of the present invention.

FIG. 7 is a top side perspective view of the tub of FIG. 6 showing the partition plate of the seat set apart from the enclosure.

FIG. 8 is a representation of the water jet member of the present invention.

### DETAILED DESCRIPTION OF THE INVENTION

The system of the present invention comprises a molded shell structure that defines a tub for containing water having a top rim, a sidewall area and a floor area. In the preferred embodiment of the present invention, the shell sidewall area comprises of at least one section contoured to accommodate one seat for a bather. Each section contains at least one enclosure molded into the shell. Each enclosure comprises a recessed inside surface area molded in the shell, raised sidewalls molded around the enclosure, and a removable partition plate wedged into the recessed area. The partition plate has an outer and an inner surface and is contoured to fit the side walls of the enclosure. Each enclosure also has a bottom that is nearest to the floor area and a top that is nearest the top rim of the tub.

Each partition plate comprises one or more female threaded holes. A water jet member having a male threading portion is threaded into each hole. In a typical arrangement, each section represents one seat for one bather formed by one partition plate. In an alternate embodiment, a seat comprises of up to four contoured enclosures each designed to accommodate one plate. These may include a back rest, a seat, a leg support and a neck rest. The plates combine to form one seat for a bather and may contain no jets or one or more jets.

The water jet member comprises of an orifice having a male threaded portion and a jet head adapted for fitting into the orifice. The male threaded portion may be part of a commercially available water jet assembly product or one described in the art. In a typical water jet assembly, the male threaded portion is adapted for threading into existing plumbing such as fittings for pipes used for channelling water to the jets. For the purpose of the present invention, the male threaded portion is threaded into female threaded holes adapted for the male threaded portion.

In the preferred embodiment of the present invention, the bathing system comprises of a floor area below each section that is sunken relative to the seat sections of the tub.

A channel distribution system for supplying and distributing water to the jets is molded into the recessed inside surface of each enclosure section. The channel system comprises of a main furrow that runs from the bottom of the enclosure to substantially the top of the enclosure. The channel system also comprises of grooves that branch off the main furrow to the other parts of the enclosure shell such that each jet placed on the partition plate is in communication with a channel groove directly beneath it. The part of the furrow at the bottom of the enclosure is open while the part at the top of the enclosure is closed. The open part of the furrow serves as the water inlet to the channel system.

The partition plates are bolted to the shell at multiple locations preferably around the rim of the partition plate. The bolts are threaded through the partition plate and through the recessed inside surface area of the enclosure. A tightening nut placed behind the shell is threaded onto the end of the bolt to keep it firmly in place. The head of each bolt is placed in a recessed area on the partition plate outer surface such that the head of the bolt is flush with the surface of the plate. Washers are used underneath the heads of the bolts and the tightening nuts. They are tightened against the partition plate and the outside shell surface respectively to prevent water leaking.

The bottom surface of each partition plate is designed to be substantially flush with the recessed inside surface area of the enclosure directly underneath it. The outside rim of each partition plate is fabricated to tightly fit the contoured walls of the enclosure into which it is placed. A centrifugal pump having a feed side and a suction side is placed near the outside of the shell wall of each section. The feed side of the pump is fitted into the bottom part of the main furrow through a hole drilled in the floor area of the shell. The suction side of the pump is placed into the floor area immediately adjacent to that section.

The tub is initially filled with water to a level that typically covers the all the water jets. The pump for each section circulates the water from the tub through the channel system and transfers the water into the tub through the jets. In this way, the pumps supply water pressure to each jet through the channel distribution system.

In the preferred embodiment of the present invention, an air compressor supplies air to the jets through the outlet of the pump, where the air is injected and mixes with the water.

In an alternate embodiment, a separate air supply system feeds air to each jet separately. In yet another embodiment, an air compressor is adapted to inject air directly into each branch of the water channel through a main air line placed inside the enclosure that has connections to each grooved branch of the channel.

Cleaning the inside of the tub involves draining the water from the tub, removing the partition plates, and cleaning the channel grooves. After the cleaning is completed, the partition plates are reassembled and the water replaced.

The preferred material for the shell and the partition is a combination of fibreglass and acrylic. However, other plastic materials such as PVC and styrene also fall within the scope of the present invention. The thickness of the partition plate can range from 0.25″ to 1.5″, the thickness of the shell may range from 2″ to 4″ and the depth of the channel can vary from 0.25″ to 2″.

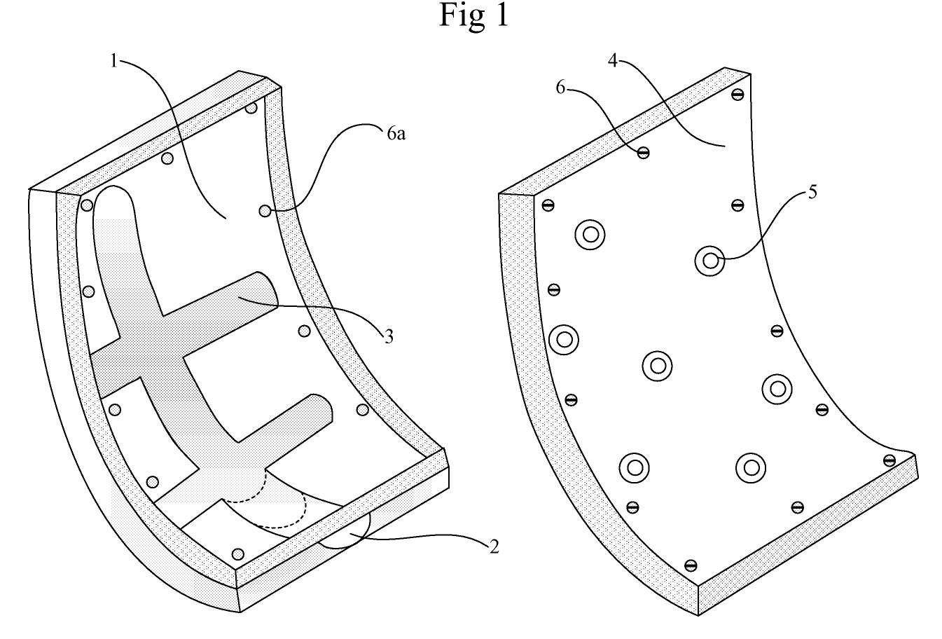

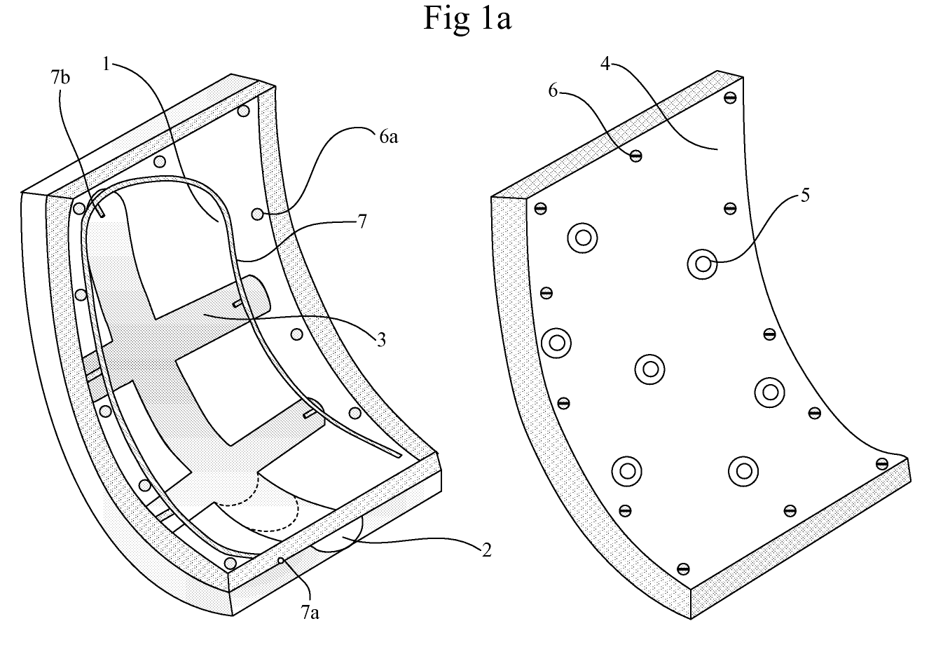

Referring to FIG. 1, the enclosure (1) contains a channel system having a main channel furrow (2) and channel grooves (3) that branch from the main furrow. A partition plate (4) containing a plurality of jets (5) and a plurality of bolts (6) for fastening onto the shell is shown separately. The bolts go through holes (6a) drilled through the inside surface of the enclosure (1).

FIG. 1a shows the enclosure of FIG. 1 further comprising an air supply line (7) having an entrance port for the air (7a) and having open pipe connections to the water channel grooved branches. This represents the preferred embodiment for injecting air into the water system. Also indicated are extensions of the air supply line used for injecting air into the entrance to the water jets in the channel (7b).

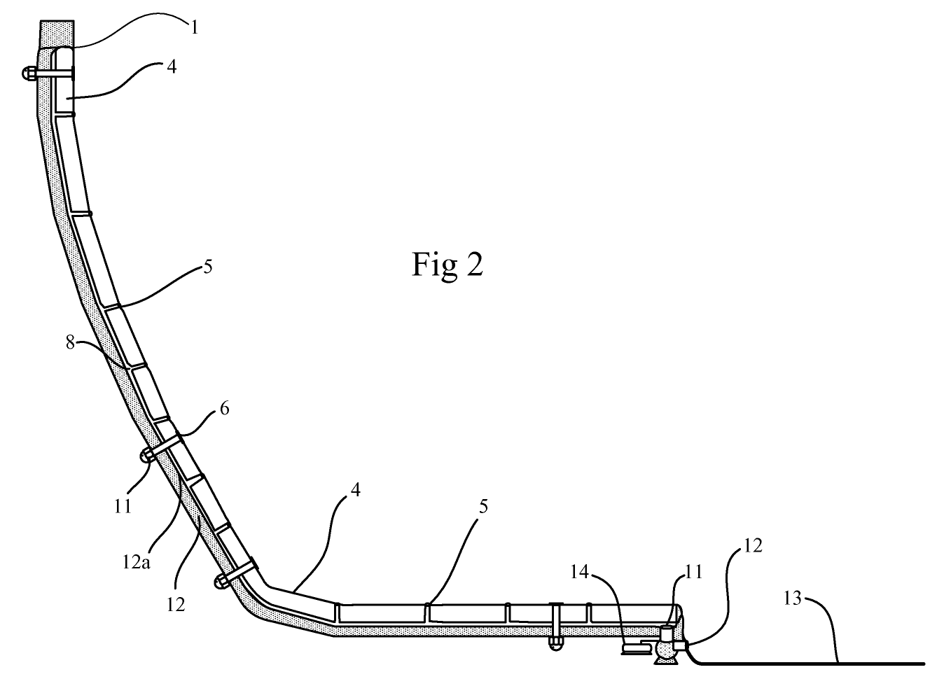

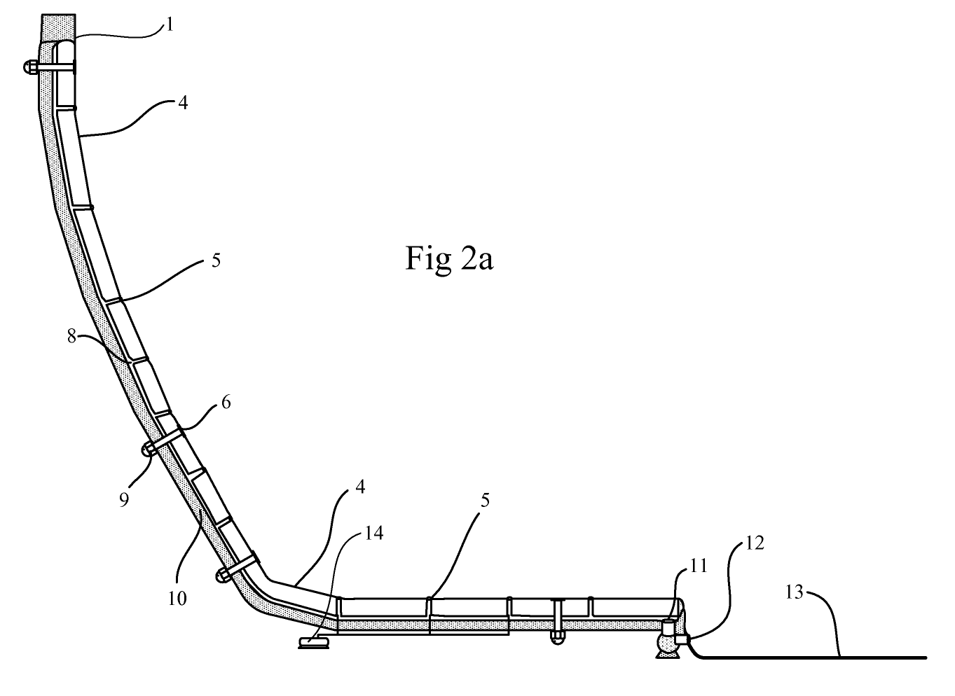

FIG. 2 illustrates the partition plate (4) wedged in the enclosure (1) indicating the shell (12), the recessed inside surface area of the enclosure (12a), and the channel (8) under the partition plate (4). The partition plate comprises of jets (5) and bolts (6) that are held firm by tightening nuts (9) located outside the shell and are threaded onto the bolts (6). The bolts hold the partition plate in and ensure that the partition plate does not come loose when the water pump is running. The pump outlet (11) is placed into the bottom of the channel (8) while the pump inlet (10) is placed in the floor area (13). An air compressor (14) supplies air to the outlet of the water pump (11) representing one design embodiment for introducing air into the water system.

FIG. 2a depicts the enclosure of FIG. 2 indicating the embodiment of direct air injection into the jets from the air compressor (14).

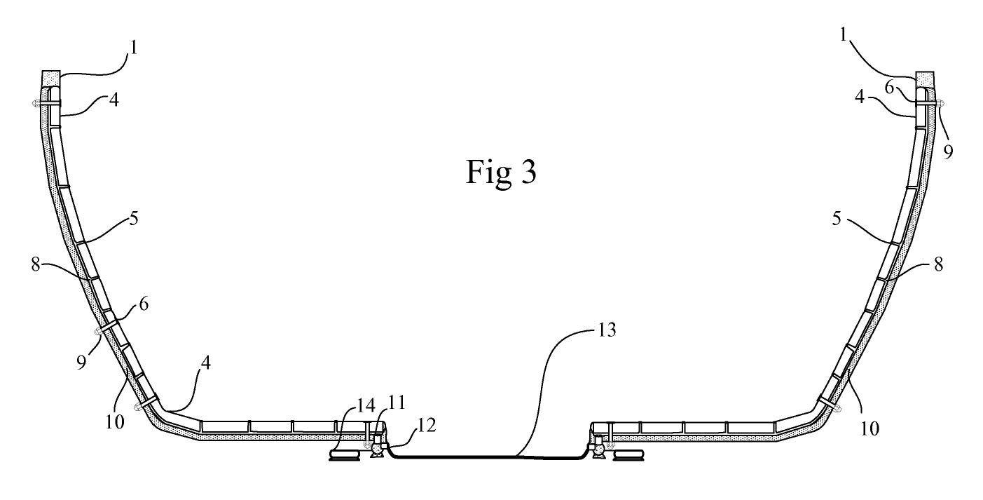

FIG. 3 illustrates two enclosures shown in FIG. 2 in one molded shell tub indicating a common floor area (13).

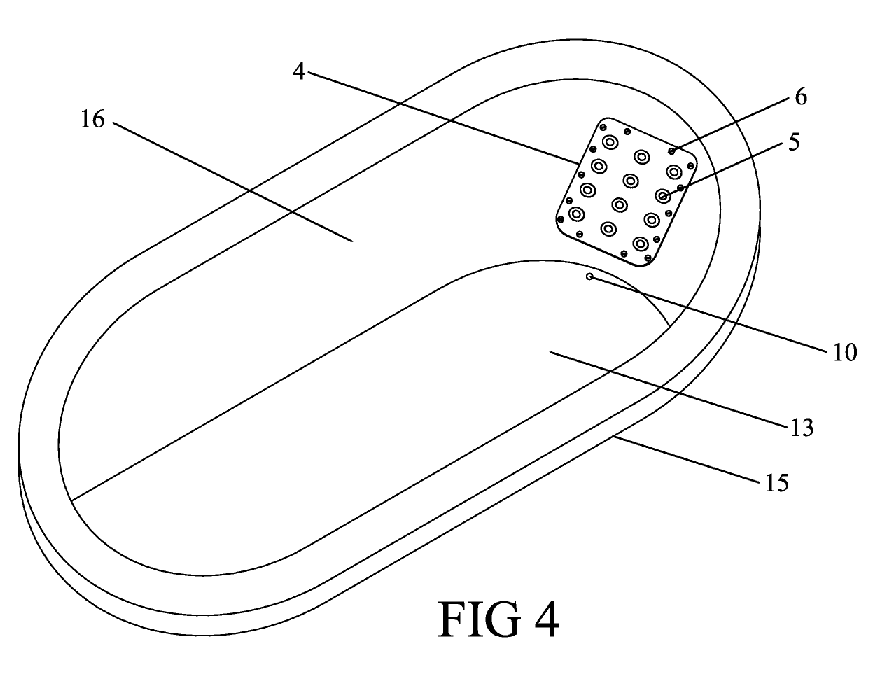

FIG. 4 is a top side view of a tub (15) outfitted with the partition plate (4) of the present invention placed on the tub sidewall (16) having jets (5) and bolts (6) for locking the plate (4) in place. The tub has a floor area (13).

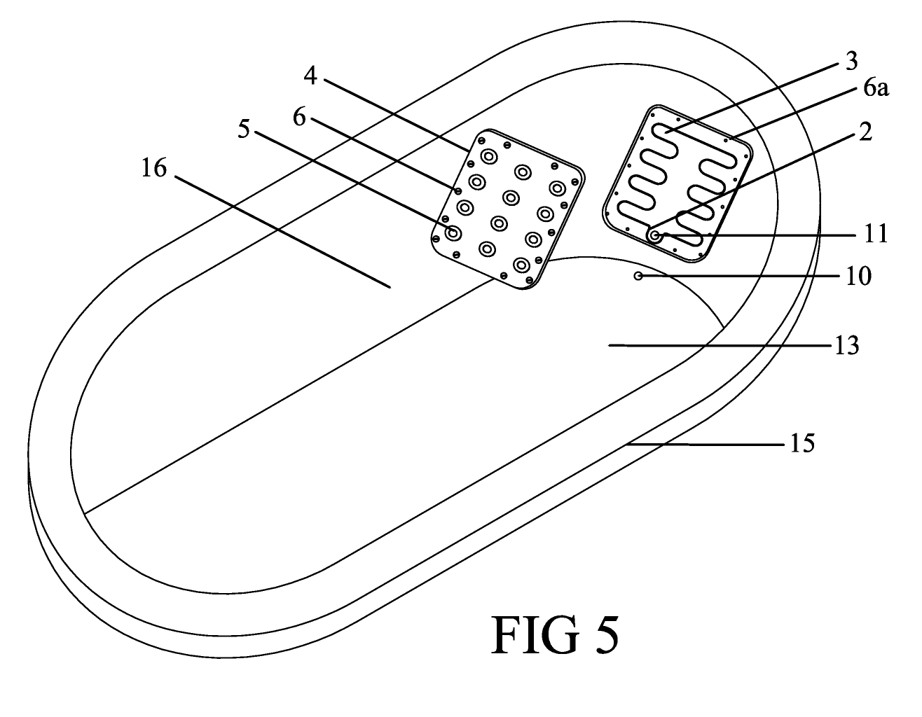

FIG. 5 illustrates the tub of FIG. 4 and indicating the partition plate (4) removed from the enclosure (1) showing the bottom of the furrow (2) and the channel grooves (3).

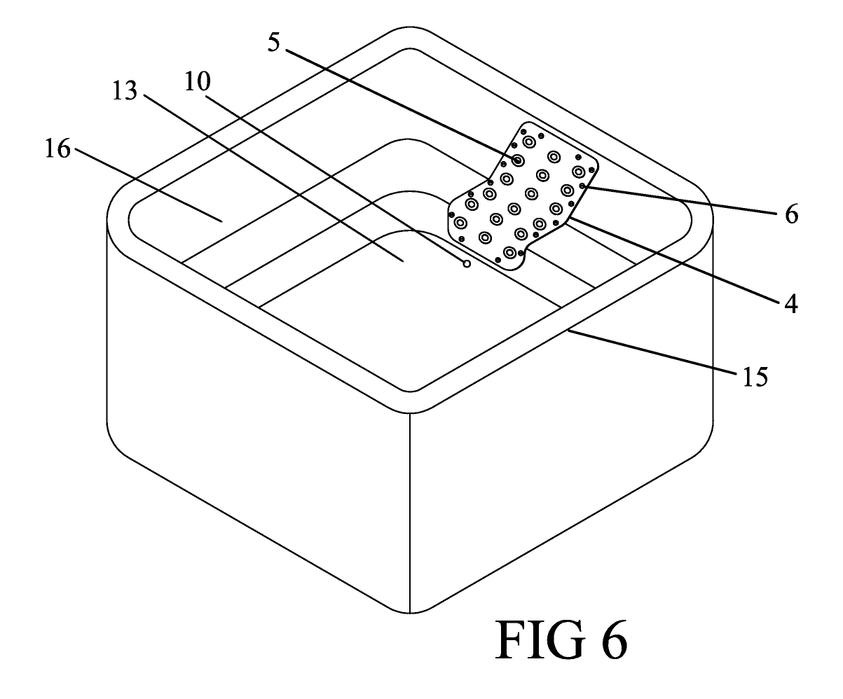

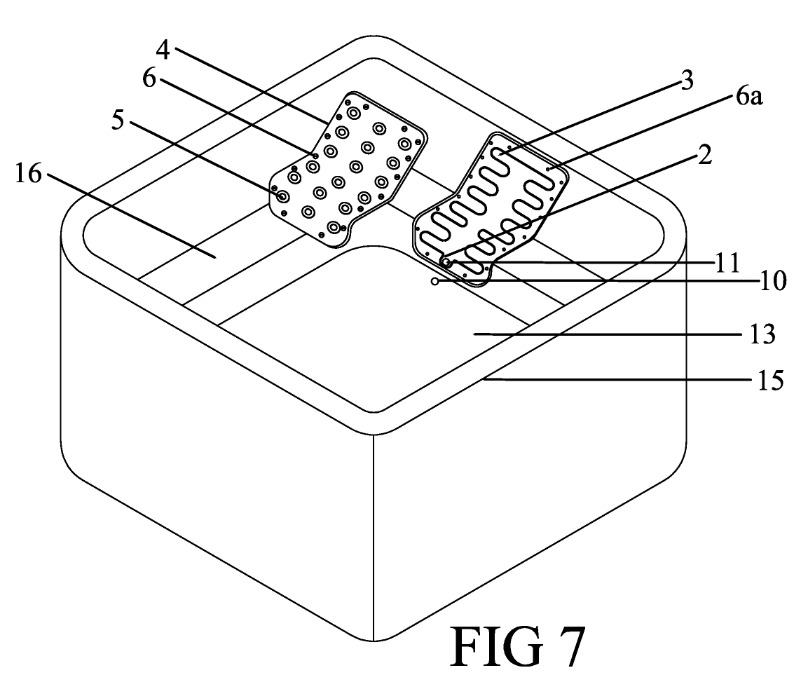

FIG. 6 is a top view of a tub (15) outfitted with a full seat comprising of one partition plate (4) placed on the tub sidewall (16) having jets (5) and bolts (6) for locking the plate (4) in place. The tub has a floor area (13). FIG. 7 portrays the tub of FIG. 6 indicating the full seat comprising of one partition plate (4) having jets (5) and bolts (6) removed from the enclosure (1). Shown in the enclosure (1) are the bottom of the furrow (2) and the channel grooves (3).

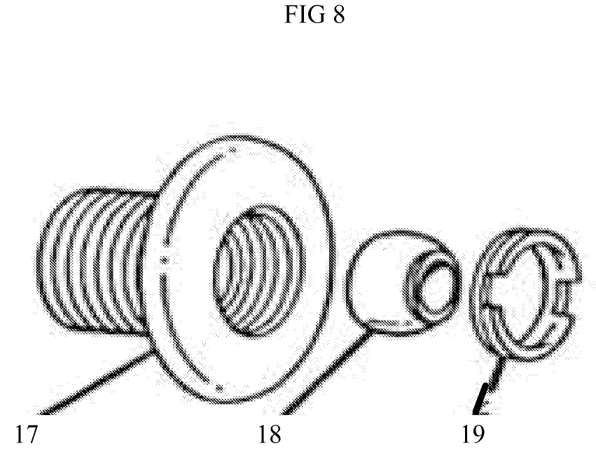

FIG. 8 illustrates the water jet member of the present invention having a threaded orifice (17), a jet head (18), and a fitting (19) for the jet head (18) into the orifice (17).

I claim:

1. A bathing system containing a molded shell structure defining a water tub having a floor area and a sidewall area and an outside, said shell structure sidewall area comprising at least one contoured enclosure molded into the shell, said enclosure comprising:
A. a recessed inside surface area;
B. raised sidewalls molded around said enclosure;
C. a channel system molded into the recessed inside surface area of said enclosure comprising of a main furrow and a plurality of grooves branching off the main furrow, said furrow having a top and a bottom;
D. a removable partition plate having an inside and an outside, said partition plate comprises of a plurality of water jets, said partition plate is placed inside the enclosure and said water jets are in communication with the channel system.

2. The bathing system of claim 1, wherein said plate further comprises a plurality of bolts for securing said partition plate to the shell.

3. The bathing system of claim 2, wherein each bolt has a head and a threaded portion, said head is placed in a recessed area on the partition plate in a manner that the head of the bolt is substantially flush with the outside of the partition plate, said threaded portion is threaded through the partition plate and through the recessed inside surface area of said enclosure.

4. The bathing system of claim 3, wherein each bolt is adapted with a tightening nut for securing said bolt, said tightening nut is placed outside the shell structure, said tightening nut is threaded onto said bolt and tightened against the outside of the shell structure.

5. The bathing system of claim 1, further comprising a circulating pump having an inlet and an outlet, said outlet is placed into the bottom of the furrow and said inlet of the pump is placed into the floor area of the water tub.

6. The bathing system of claim 1, further comprising an air supply system for mixing air with the water.

7. The bathing system of claim 6, wherein the air supply system comprises of an air compressor and an air supply line, said supply line compresses air directly into the water at the pump inlet.

8. The bathing system of claim 6, wherein the air supply system comprises of an air compressor and air supply lines that inject air directly into the jets.

9. The bathing system of claim 6, wherein the air supply system comprises of an air compressor and air supply lines that inject air directly into the furrow grooves.

10. The bathing system of claim 1, wherein each water jet comprises a threaded orifice member, a jet head, and a fitting.
